(19) United States
(12) Patent Application Publication
(10) Pub. No.: US 2015/0124189 A1
(43) Pub. Date: May 7, 2015

(54) LIQUID CRYSTAL DISPLAY DEVICE AND MANUFACTURING METHOD THEREOF

(71) Applicant: Japan Display Inc., Tokyo (JP)

(72) Inventors: Saori SUGIYAMA, Tokyo (JP); Yuji MAEDE, Tokyo (JP)

(73) Assignee: Japan Display Inc.

(21) Appl. No.: 14/532,029

(22) Filed: Nov. 4, 2014

(30) Foreign Application Priority Data
Nov. 6, 2013 (JP) 2013-230506

(51) Int. Cl. G02F 1/1343; G02F 1/1362; G02F 1/1333; G02F 1/1368

(52) U.S. Cl. CPC G02F 1/13439; G02F 1/1368; G02F 1/136286; G02F 1/134363; G02F 1/133345; G02F 2001/136295
USPC 349/43; 349/139; 438/30

(57) ABSTRACT

In a liquid crystal display device which uses transparent conductive films as common wirings, the common wirings have common metal wirings, including metal wirings extending in a vertical direction and metal wirings extending in a horizontal direction in a mesh-like form.

### CLAIM OF PRIORITY

The present application claims priority from Japanese patent application JP 2013-230506 filed on Nov. 6, 2013 the content of which is hereby incorporated by reference into this application.

### TECHNICAL FIELD

The present invention relates to a liquid crystal display device and a manufacturing method thereof.

### BACKGROUND ART

In large screen/high resolution monitor products (pixels of approximately 10M/30 in) for broadcasting/medical use, smear is likely to occur, because the wiring resistance is high due to the wiring length. This tendency has been recognized also in C-Top IPS (In-Plane Switching) liquid crystal display devices, in which the common wirings formed with a transparent conductive film (ITO) are arranged on the upper part of the pixel electrodes. Thus, as countermeasures for the smear, horizontal common metal wirings whose potential is equal to that of the common ITO have additionally been formed, in order to achieve low resistance, particularly, in a large horizontal direction. FIG. 1A illustrates a schematic plan view of a partial configuration of a display region of a liquid crystal display device. Drain lines 105 as video signal lines are arranged in a vertical direction, pixels are in regions enclosed by the drain lines 105 and horizontally-arranged scanning signal lines, and many common ITO wirings 110 are arranged in the pixel region. Horizontal common metal wirings 101h are arranged in regions (horizontal direction) overlapping scanning signal line (gate wirings). Japanese Unexamined Patent Application Publication No. Hei6-118449 discloses the configuration in which a metal electrode layer is covered by an ITO electrode layer.

### SUMMARY OF THE INVENTION

### Technical Problem

There is a tendency that the liquid crystal display device for monitor products has a large screen and high resolution. Based on some experimental products of the large screen liquid crystal display device, it is clear that the addition of the horizontal common metal wirings is not a sufficient countermeasure for the smear. To further lower the common wiring resistance, the inventor has examined a configuration in which vertical common metal wirings whose potential is equal to the common ITO are added to the horizontal common metal wirings, and the horizontal common metal wirings and the vertical common metal wirings are arranged in a mesh-like form. FIG. 1B illustrates a schematic cross sectional view of a partial configuration of a display region of this liquid crystal display device. Vertical common metal wirings 101v are arranged in regions overlapping the drain lines 105 as video signal lines. However, although the metal wirings are arranged both vertically and horizontally in a mesh-like form, it is clear that the common wiring resistance is not decreased as expected, thus enabling to perform the sufficient countermeasure for the smear.

An object of the present invention is to provide a liquid crystal display device which can reduce and prevent occurrence of smear even in large screen/high-resolution monitor products and a manufacturing method of manufacturing the liquid crystal display device with high yield.

### Solution to Problem

In order to attain the above object, according to an embodiment, there is provided a liquid crystal display device which uses transparent conductive films as common wirings, the device comprising

common metal wirings in a mesh-like form extending in a vertical direction and a horizontal direction, in the common wirings.

There is provided a manufacturing method of a liquid crystal display device which uses transparent conductive films as common wirings, wherein

the common wirings further have common metal wirings in a mesh-like form extending in a vertical direction and a horizontal direction, the method comprising:

a first step of forming the transparent conductive films having a predetermined form, on insulating films; and thereafter

a second step of forming common metal films for the common metal wirings extending in the vertical direction, and processing the common metal films in a predetermined form.

There is provided a manufacturing method of a liquid crystal display device which uses the transparent conductive films as common wirings, wherein

the common wirings further have common metal wirings in a mesh-like form extending in the vertical direction and the horizontal direction, the method comprising:

a first step of forming common metal wirings extending in the vertical direction with a predetermined form; and thereafter

a second step of forming the transparent conductive films and photoresist films, and processing the transparent conductive films in a predetermined form, while leaving the photoresist films in a manner to cover the transparent conductive films formed on an upper surface and both side surfaces of the common metal wirings.

### Advantageous Effect of the Invention

According to the present invention, it is possible to provide a liquid crystal display device which can reduce and prevent occurrence of smear even in large screen/high-resolution monitor products and a manufacturing method of manufacturing the liquid crystal display device with high yield.

### BRIEF DESCRIPTION OF DRAWINGS

FIG. 1A is a schematic plan view of the main part (pixel portions including common wiring) of a display region in a conventional liquid crystal display device.

FIG. 1B is a plan view of the main part (common wiring) of a liquid crystal display device according to each embodiment, as examined by the inventor.

FIG. 2 is a process flow of the main manufacturing processes for pixel regions of the liquid crystal display device according to each embodiment, as examined by the inventor.

FIG. 3 is a plan view of the main part (common wiring) of the liquid crystal display device according to each embodiment as examined by the inventor, and an enlarged plan view of a vertical common wiring unit.

FIG. 4A is a cross sectional view along a line A-B illustrated in FIG. 3, and shows a state in which a photoresist film is formed on ITO covering processed metal wiring, in the manufacturing method of the liquid crystal display device examined by the inventor.

FIG. 4B is a cross sectional view along the line A-B illustrated in FIG. 3, and shows a state after the photoresist film of FIG. 4A has been developed, in the manufacturing method of the liquid crystal display device examined by the inventor.

FIG. 5A is a cross sectional view along the line A-B illustrated in FIG. 3, and shows a state in which the photoresist film is developed on the metal wiring covering the processed ITO, in the manufacturing method of the liquid crystal display device according to a first embodiment of the present invention.

FIG. 5B is a cross sectional view along the line A-B illustrated in FIG. 3, and shows a state in which the photoresist film is developed on the ITO covering the processed metal wiring, in the manufacturing method of the liquid crystal display device according to a second embodiment of the present invention.

FIG. 6 is an example of a monitor product according to a conventional technique and each embodiment.

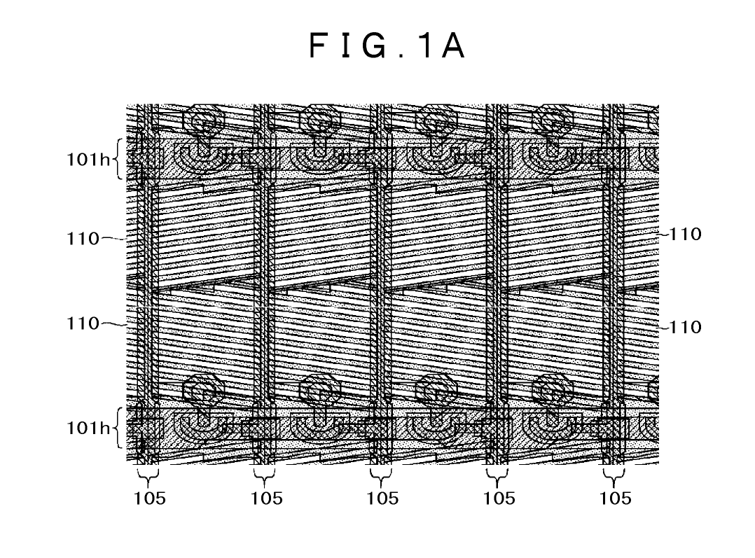

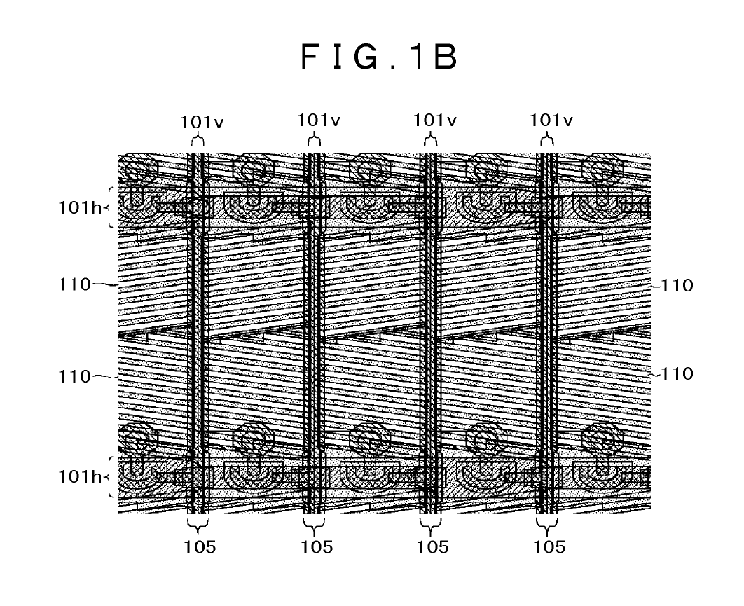

### DESCRIPTION OF THE PREFERRED EMBODIMENTS

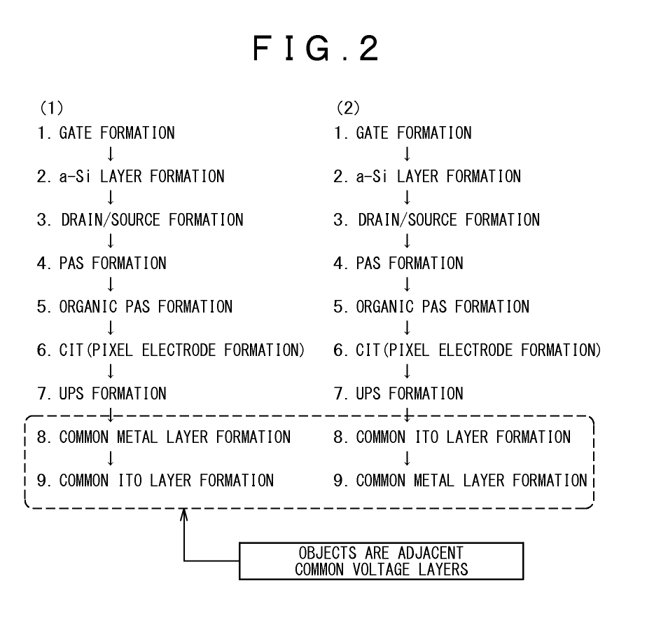

The present inventor has examined the reason why the low resistance common wiring cannot be obtained regardless of a mesh-like configuration in which vertical common metal wirings are added to horizontal common metal wirings. FIG. 2 illustrates a process flow (1) of the main manufacturing processes for a pixel region, examined by the inventor. The processes 1 to 3 are performed to form thin film transistors (TFT) for switching to be formed in the pixel region and drain lines connected to the drains of the TFTs. Pixel electrodes (CIT) connected to the sources of the TFTs are formed (process 6), after having formed inorganic passivation (PAS) films (process 4) and organic passivation films (process 5). Upper inorganic passivation films (UPS) are formed (process 7). Then, common metal layers and common ITO are formed (processes 8 and 9). Attention has been given, particularly, to vertical common wirings, because the horizontal common metal wirings have already achieved the past performance and thus are considered to have high reliability.

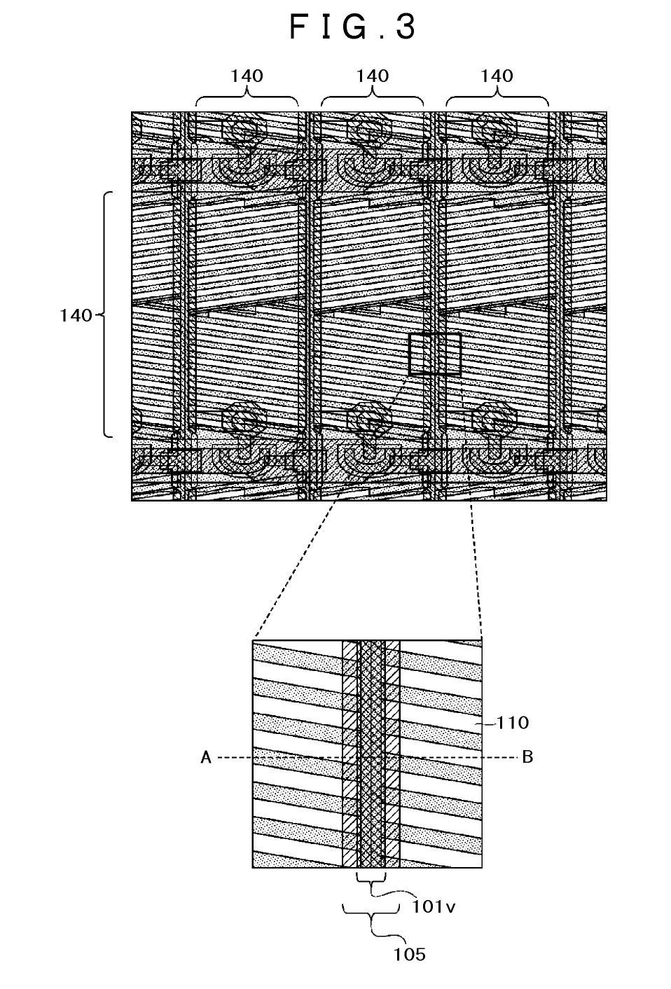

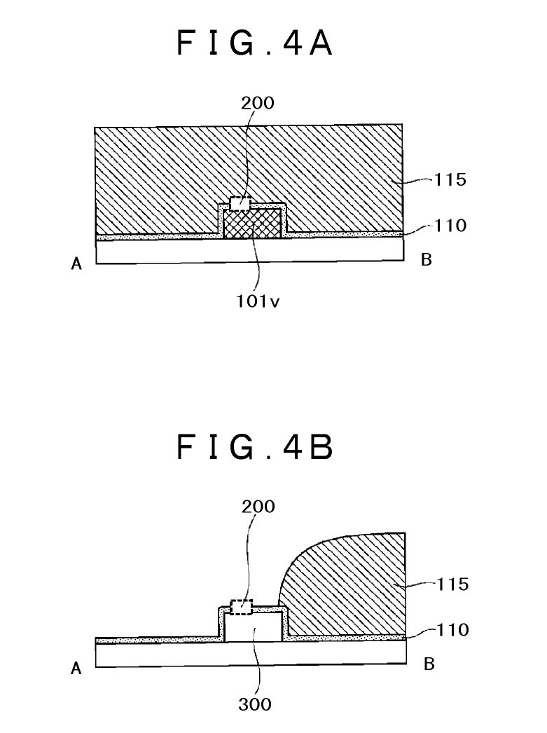

FIG. 3 illustrates a plan view of the main part (common wirings) of the liquid crystal display device examined by the inventor, and an enlarged plan view of the vertical common wiring unit. Regions with reference numerals 140 are pixel regions, and cross each other in a vertical direction and a horizontal direction. Vertical common metal wirings 101v are arranged in regions overlapping drain lines 105 as video signal lines. FIG. 4A and FIG. 4B illustrate cross sectional views along a line A-B shown in FIG. 3 in a case where the low resistance common wiring cannot be obtained. FIG. 4A illustrates a state in which a photoresist film 115 is formed on a common ITO film 110 covering the processed vertical common metal wiring 101v, in the manufacturing method of the liquid crystal display device. FIG. 4B illustrates a state in which the photoresist film 115 is developed, after exposure thereof shown in FIG. 4A.

As a result of this examination, if the low resistance common wiring cannot be obtained, it is understood that a cavity 300 has been made due to the disappearance of the vertical common metal wiring 101v which existed before the development. The reason why the vertical common metal wiring has disappeared has been examined. As a result of the examination, if the common ITO film 110 is processed after processing the vertical common metal wiring 101v, when a defect 200 (pinhole, etc.) exists in the common ITO film, a liquid developer at the processing of the common ITO film 110 intrudes from the defect 200 onto the side of the vertical common metal wiring. Thus, it is estimated that a metal solution is generated due to a cell reaction. The inventor has understood that it is possible to prevent the disappearance of the common metal, in a configuration where the vertical common metal wiring, the common ITO with the defect, and the liquid developer are not simultaneously in contact with each other. The present invention has been made based on the above new finding, and uses common ITO wiring as common wiring and the mash-like common metal wiring formed of vertical/horizontal common metals. According to the manufacturing method, (1) after the common ITO film is patterned, a common metal film is formed to be patterned, (2) when a common ITO film is formed after the common metal film is formed, the common ITO film is formed after patterning the common metal film, a photoresist film is left to cover the upper surface and both side surfaces of the common metal film through the common ITO film, and the common ITO film is patterned. Preferred embodiments of the present invention will hereinafter be described. The same reference numerals identify the same constituent elements.

### First Embodiment

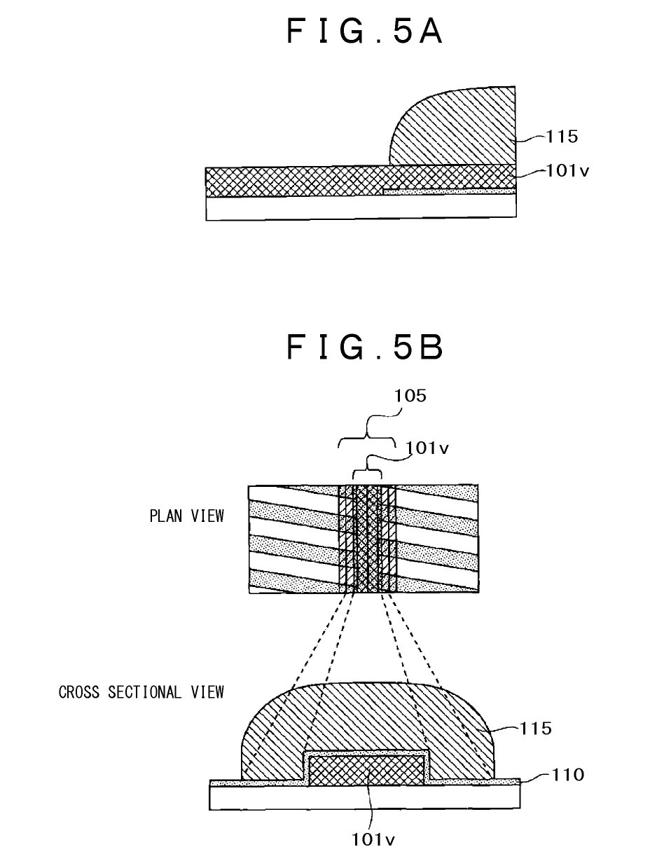

A first embodiment of the present invention will now be described with reference to FIG. 2 and FIG. 5A. Of the above examined results by the inventor, those matters not described in this embodiment may be applied to this embodiment, unless there are special circumstances. In FIG. 2, (2) denotes a process flow of the main manufacturing processes for the pixel region in the liquid crystal display device (IPS type C-Top) according to this embodiment. Descriptions will now be made to the manufacturing method, using this drawing.

### <Process 1: Form Gate>

First, a gate electrode is formed on a glass TFT substrate. The gate electrode is formed in the same layer as a scanning signal line. The gate electrode is formed using a laminated layer in which a Mo alloy is formed on top of an Al alloy, but is not limited to this. An insulating film is formed of SiN. A part of this insulating film covering the gate electrode is a gate insulating film.

<Process 2: Form a-Si>

Subsequently, a semiconductor layer is formed in a position opposed to the gate electrode through the gate insulating film. In this embodiment, an a-Si film is formed using a plasma CVD technique, as a semiconductor layer. This semiconductor layer is to form a channel unit of the TFT.

### <Process 3: Form Drain/Source>

A source electrode and a drain electrode are formed on the semiconductor layer across the channel unit. An n+Si layer is formed between the semiconductor layer and the drain electrode or the source electrode. This is to make an ohmic contact with the semiconductor layer and the source electrode or the drain electrode. The drain electrode is used also as a video signal line. The source electrode and the drain electrode are formed simultaneously and in the same layer. In this embodiment, the source electrode or the drain electrode is formed of a No alloy. When the electric resistance of the source electrode or the drain electrode is lowered, it is possible to use an electrode structure in which, for example, an Al alloy is sandwiched by the Mo alloy. The name of the “source/drain” is conveniently given. When one of them is assumed as “source”, the other may be called “drain”.

### <Process 4: Form PAS>

An inorganic passivation (PAS) film is formed of SiN, and covers the TFT. The PAS film protects the TFT, particularly its channel unit, from impurities.

### <Process 5: Form Organic PAS>

An organic PAS film is formed on the PAS film. There is formed an opening unit from which the source electrode is exposed, in the laminated film of the PAS film and the inorganic PAS film.

### <Process 6: CIT (Form Pixel Electrode)>

ITO (Indium Tin Oxide) is formed using a sputtering technique, as a pixel electrode. The ITO covers the laminated film of the PAS film and the organic PAS film. The laminated film includes an opening unit from which the source electrode is exposed. The pixel electrode is formed in a sheet-like form.

### <Process 7: Form UPS>

An upper inorganic passivation (UPS) film is formed of SiN, and covers the pixel electrode.

### <Process 8: Form Common ITO>

The ITO (Indium Tin Oxide), as a transparent conductive film, is sputtered to be formed entirely over the display region. The sputtered ITO is patterned to form common ITO wiring. The common ITO wiring has a comb-teeth electrode structure.

### <Process 9: Form Common Metal>

A common metal film is formed, and a photoresist film is developed, after applying the photoresist film for processing the common metal film thereto and exposure thereof. After this, an opposed substrate having a color filter or black matrix and the TFT substrate are attached together through a liquid crystal, thereby forming a liquid crystal display device.

FIG. 5 is a cross sectional view along the line A-B of FIG. 3, and illustrates a state in which the photoresist film 115 is developed, in the process flow (2) of FIG. 2. This photoresist film 115 is formed on the vertical common metal film 101v covering the processed common ITO wiring. In this manufacturing method, when to develop the photoresist film 115, even if the common ITO film has a defect, no cell reaction is generated, because the liquid developer, the common metal film, and the common ITO film are not simultaneously in contact with each other. This results in that the common metal film is not to dissolve.

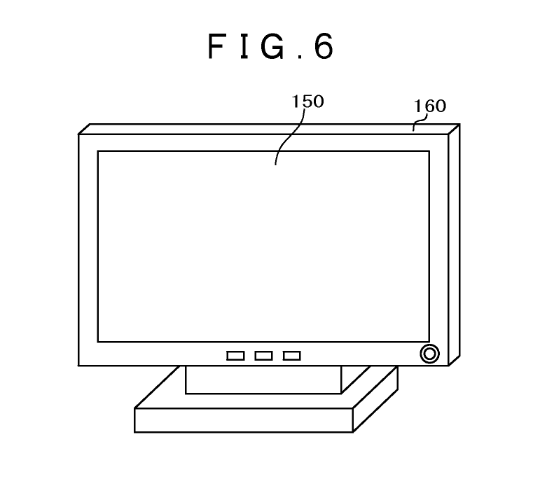

According to the manufacturing method including the process flow (2) of FIG. 2, what is formed is a liquid crystal display device having the common wiring, in which the mesh-like configuration including the horizontal common metal wiring and the vertical metal wiring is added to the common ITO wiring, and it is applied to a display unit 150 of the monitor product illustrated in FIG. 6. As a result, it is possible to reduce and prevent occurrence of smear, and also to obtain preferable manufacturing yield. A reference numeral 160 denotes a frame. The common metal is assumed to have a configuration in which aluminum is sandwiched by Mo (molybdenum) or MoCr (molybdenum chrome). However, the effect of the present invention can be attained, even using another kind of metal that causes a cell reaction with ITO.

According to this embodiment, the common metal film is formed after forming the common ITO film. As a result, it is possible to provide a liquid crystal display device which can reduce and prevent smear even in large screen/high-resolution monitor products and a manufacturing method for manufacturing the liquid crystal display device with high yield.

### Second Embodiment

Descriptions will now be made to a second embodiment of the present invention, using FIG. 2 and FIG. 5B. Those matters described in the first embodiment but not described in this embodiment may be applied to this embodiment, unless there are special circumstances. In FIG. 2, (1) denotes a process flow of the main manufacturing processes for the pixel region in the liquid crystal display device according to this embodiment. Descriptions will now be made to the manufacturing method, using this drawing.

Like the first embodiment, according to the processes 1 to 3, a TFT for switching is formed in the pixel region. Then, an inorganic passivation (PAS) film (process 4) is formed, an organic passivation film (process 5) is formed, and a pixel electrode (CIT) is formed (process 6). Next, an upper inorganic passivation film (UPS) is formed (process 7).

After this, a common metal film is formed on the upper passivation film formed in the process 7 (process 8), and the common metal film is processed in a predetermined shape. A common ITO film is formed (process 9), and a photoresist film is developed, after application and exposure of the photoresist film for processing the common ITO film. FIG. 5B is a cross sectional view along the line A-B illustrated in FIG. 3, and illustrates a state in which the photoresist film is developed on the ITO covering the processed metal wiring, in the process flow (1) of FIG. 2. The difference between this embodiment and the configuration examined by the present inventor is that, in this embodiment, the common ITO film 110 covering the processed vertical common metal wiring 101v is covered entirely by the developed photoresist film 115. According to this manufacturing method, unlike the configuration examined by the inventor (FIG. 4B), the common ITO film covering the processed vertical common metal wiring 101v is covered entirely (upper surface and both side surfaces) by the developed photoresist film 115. Thus, when to develop the photoresist film 115, even if the common ITO film 110 has a defect, no cell reaction is generated, because the liquid developer, the common metal film, and the common ITO film are not simultaneously in contact with each other. This results in that the common metal film is not to dissolve.

According to the manufacturing method including the process flow (1) of FIG. 2, there is manufactured the liquid crystal display device including the common wiring, in which the mesh-like configuration including the horizontal common metal wiring and the vertical metal wiring is added to the common ITO wiring, and it is applied to the display unit 150 of the monitor product illustrated in FIG. 6. As a result, it is possible to reduce and prevent occurrence of smear, and also to obtain preferable manufacturing yield. A reference numeral 160 denotes a frame. The common metal is assumed to have a configuration in which aluminum is sandwiched by Mo (molybdenum) or MoCr (molybdenum chrome). However, the effect of the present invention can be attained, even using another kind of metal that causes a cell reaction with ITO.

According to this embodiment, because the common ITO film 110 covering the processed vertical common metal wiring 101v is covered entirely by the developed photoresist film 115, it is possible to provide a liquid crystal display device which can reduce and prevent occurrence of smear even in large screen/high-resolution monitor products and its manufacturing method for manufacturing the liquid crystal display device with high yield.

The present invention is not limited to the above-descried embodiments, and various modification are possible. For example, the above-described embodiments have been described in detail for easy explanations, and are not limited to the configuration including the entire constituent elements. A part of the configuration of one embodiment may be replaced by another configuration of another embodiment, and the configuration of one embodiment may be added to the configuration of another embodiment. A part of the constituent elements of each embodiment may be added to, deleted from, and/or replaced by any of another embodiment.

What is claimed is:

1. A liquid crystal display device comprising a display region having common wirings,
wherein the common wirings are formed of transparent conductive films and common metal wirings which have a mesh-like form extending in a vertical direction and a horizontal direction.

2. The liquid crystal display device according to claim 1, further comprising
thin film transistors, drain lines connected to the thin film transistor, and pixel electrodes, and wherein
the common metal wirings extending in the vertical direction are arranged in regions overlapping the drain lines, as seen vertically from above.

3. The liquid crystal display device according to claim 1, wherein the liquid crystal display device is of an IPC type.

4. The liquid crystal display device according to claim 2, wherein the common wirings are arranged upward the pixel electrodes.

5. A manufacturing method of a liquid crystal display device which uses transparent conductive films as common wirings,
wherein the common wirings further have common metal wirings in a mesh-like form extending in a vertical direction and a horizontal direction, the method comprising:
a first step of forming the transparent conductive films having a predetermined form, on insulating films; and thereafter
a second step of forming common metal films for the common metal wirings extending in the vertical direction, and processing the common metal films in a predetermined form.

6. The manufacturing method of the liquid crystal display device, according to claim 5,
wherein thin film transistors, drain lines connected to the thin film transistors, and pixel electrodes are arranged below the insulating films; and
the second step includes a step of processing the common metal films to overlap the drain lines, as seen vertically from above.

7. The manufacturing method of the display device, according to claim 5, wherein the liquid crystal display device is of an IPC type.

8. The manufacturing method of the display device, according to claim 6,
wherein the common wirings are arranged above the pixel electrodes.

9. A manufacturing method of the liquid crystal display device which uses the transparent conductive films as common wirings,
wherein the common wirings further have common metal wirings in a mesh-like form extending in the vertical direction and the horizontal direction, the method comprising:
a first step of forming common metal wirings extending in the vertical direction with a predetermined form; and thereafter
a second step of forming the transparent conductive films and photoresist films, and processing the transparent conductive films in a predetermined form, while leaving the photoresist films in a manner to cover the transparent conductive films formed on an upper surface and both side surfaces of the common metal wirings.

10. The manufacturing method of the liquid crystal display device, according to claim 9,
wherein thin film transistors, drain lines connected to the thin film transistors, and pixel electrodes are arranged below the insulating films; and
the first step includes a step of processing the common metal films to overlap the drain lines, as seen vertically from above.

11. The manufacturing method of the display device, according to claim 9, wherein the liquid crystal display device is of an IPC type.

12. The manufacturing method of the display device according to claim 10, wherein the common wirings are arranged above the pixel electrodes.
